(19) United States
(12) Patent Application Publication
(10) Pub. No.: US 2005/0173479 A1
(43) Pub. Date: Aug. 11, 2005

(54) Baby carrier with a seat whose backrest of which is width-adjustable

(75) Inventor: Jean-Luc Gentil, Cholet (FR)

Correspondence Address: WESTMAN CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Ampafrance, Cholet (FR)

(21) Appl. No.: 10/509,973

(22) PCT Filed: Apr. 3, 2003
(86) PCT No.: PCT/FR03/01055

(51) Int. Cl. A61G 1/00

(52) U.S. Cl. 224/158

(57) ABSTRACT

The invention relates to a baby carrier comprising a harness (3) and a carrier piece (1), forming a seat for a child, with a section forming a backrest (13), characterised in that said piece forming a backrest (13) has two sections (12) which may be brought closer to each other or brought apart in such a manner as to render the width of said backrest (13) adjustable.

The field of the invention is that of baby products. More precisely, the invention concerns a baby carrier.

There are many different techniques for carrying young children, on the back and/or on the front of a carrying adult. In particular, well known are baby carriers comprising a harness, formed in particular by two straps and generally a belt, and a seat for the child. Usually, this seat has two openings through which the baby's legs can be passed.

Numerous different types of baby carrier can be distinguished, depending on whether the baby is carried on the carrying adult's back or front, on the one hand, and whether the baby is facing towards or away from the carrying adult on the other hand.

On older baby carriers, the seat is fixed permanently to the harness. In this case, the use of the baby carrier cannot be adapted. In other cases, the harness and seat can be separated from one another.

Generally, the baby carriers known have a major disadvantage: it is difficult to install the baby in the seat. This can be clearly observed on baby carriers carried on the back, as a third person is required to install the baby once the baby carrier has been put on the wearer's shoulders.

In the case of front worn baby carriers, the wearer may be able to install himself the baby in the baby carrier. However, this operation remains difficult.

In fact, once the baby carrier has been fitted onto the shoulders, the carrying adult has to pick up the baby and lift it sufficiently high in a vertical position so as to introduce the baby's legs into the seat, to make the baby as comfortable as possible and finally attach any safety devices. These operations are not easy when the baby is awake, as the baby will move, and they are even more difficult when the baby is asleep.

Some of those baby carriers are equipped with means of adjusting the seat, in particular to adapt its position in relation to the harness and consequently to the carrying adult.

These means of adjustment are generally formed by extensions of the back section of the seat, several means of attachment distant from one another designed to be attached with additional fastenings of the harness. This allows the back section of the harness to be moved closer or further away and therefore to adapt the position of the seat to suit the wearer.

Similarly to the operations for installing the baby described above, the adjustment of the seat in relation to the harness is particularly painstaking, whether the baby is inside (the wearer usually wants to make these adjustments when the baby is inside, so as to ensure that the adjustment is suitable) or whether the baby carrier is empty.

In any case, it is always difficult to make the correct adjustment quickly, to allow the volume of the seat to be adapted to whether the baby has a lot of clothes or not, so as to optimise the baby's comfort.

Another disadvantage of the baby carriers known is that of sweating. As the seat is generally made of a non-breathable material, and has no ventilation, and surrounds the baby, the baby is likely to sweat quickly which causes problems of both comfort and hygiene. In fact there are no efficient means of ventilating the carrier.

A former document is also known, GB-2 477 164, which presents a completely different approach to carrying a baby, with a seat held by a single shoulder strap. It is obvious that this technique is neither comfortable nor ergonomic for the baby or the wearer, and consequently has not been developed. Currently, baby carriers are designed to carry babies in a seated position, against the body of an adult (in front or on the back of the wearer).

This document presents a technique which allows the back of the seat to be inclined, so that the baby can either be seated or laid down, by means of an ingenious folding of the back, which can be used by means of a connection. This aspect is of course of no interest for the current baby carriers, and in particular that of the invention. Furthermore, this technique would appear of little use in practice, and does not resolve any of the problems identified above, whether it be adapting the width of the seat to suit the baby, and in particular to the way that the baby is dressed, as the distance between the side walls remains the same, or the problem of sweating.

In particular, the invention aims to overcome these problems of the prior art.

More precisely, the aim of the invention is to provide a baby carrier which permits easy and efficient adjustment of the volume of the seat, in particular to suit the thickness of the clothes worn by the baby.

Another aim of the invention is to provide such a baby carrier that is effective in countering the problem of the baby sweating in the seat.

Thus, one aim of the invention is to provide such a baby carrier that is comfortable and hygienic for the baby.

Another aim of the invention is to provide such a baby carrier that can be used more easily than those of the prior art, including when the baby is seated in the baby carrier.

Another aim of the invention is to provide such a baby carrier, with means of adjustment that can be used in complete safety when the baby is seated in the baby carrier.

Another aim of the invention is to provide such a baby carrier that is simple in design and easy to manufacture and use.

Yet another aim of the invention is to provide such a baby carrier that allows new ergonomic and style aspects to be developed in this field.

These aims, as well as others which will subsequently become clear, are achieved by the invention which concerns a baby carrier, permitting a baby to be carried next to an adult, comprising a harness and a carrying part forming a seat for a baby, and comprising a part forming the back of the seat. According to the invention, the said part which forms the back of the seat has at least two portions that can be moved away from or closer to one another, so that the width of the said back part can be adjusted, the said portions being separated by a cut-out running along its longitudinal axis, on at least the majority of the length of the said part forming the back of the seat. At least one strip of fabric, made of a different material from that of the said back of the seat and which allows air to circulate, connecting the said portions, so as to permit ventilation and prevent the said cut out from moving beyond a maximum width.

It is therefore possible to adjust the seat easily to suit the requirements, and in particular to suit the way that the baby is dressed. The circulation of air on the baby's back, to combat sweating in particular, is made easier, and safety (to avoid the opening of the cut out being too large) is achieved simply and efficiently.

Of course, several cut outs may be provided, using the same principle.

According to a preferred characteristic of the invention, there are means of adjusting the opening of the said cut out. They may comprise in particular at least one cord running between the edges of the said cut out.

In particular, the said cord(s) may pass through a number of guide elements provided for this purpose on the edges of the said cut out or next to it, defining a lacing system.

This consequently provides an efficient and reliable system, which in addition has an original appearance.

According to different embodiments, the said adjustment means may comprise, in addition or in place of, means of attachment belonging to the following group:
self-adhesive strips;
press stud attachments;
zips
buttons.

Advantageously, the baby carrier comprises additional limiting means to prevent the said portions from exceeding a maximum distance between one another.

These limiting means may be formed by the cord described above, whose ends may be fixed.

Advantageously, the said strip(s) of fabric have 3D mesh on them.

It is also possible to provide at least two strips of fabric running laterally, perhaps made of an elastic fabric.

According to a preferred characteristic, the said harness and the said carrying part can be separated from one another. Preferentially, the carrying part is adapted to allow the baby to be carried facing towards or away from the wearer.

Preferentially, the said harness comprises two straps, whose front sections, against which the seat rests, each include a reinforcement equipped with attachment means allowing them to be attached to one another.

Advantageously, the said reinforcements have attachment means of the said carrying part.

The invention also concerns the carrying parts themselves, designed to equip a baby carrier as described above.

Other characteristics and advantages of the invention will become clearer upon reading a preferred embodiment of the invention, provided by way of a non restrictive example, and the drawings among which:

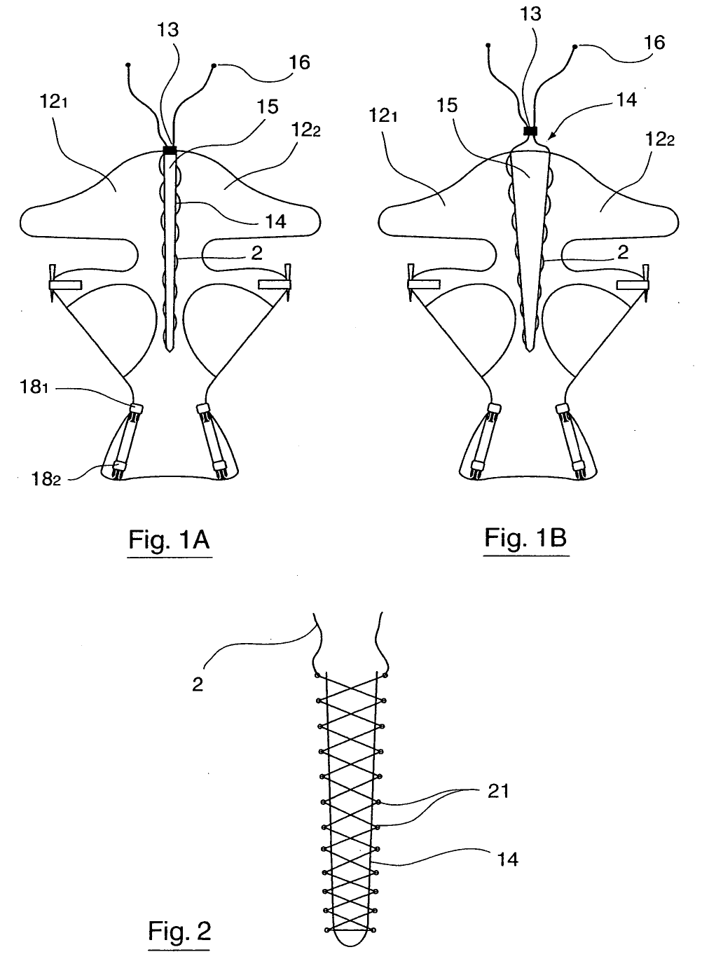

FIGS. 1A and 1B are views of a baby carrier seat according to the invention, respectively when it has a reduced and enlarged back width;

FIG. 2 is a detailed view of the means for adjusting the width of the seat of the baby carrier of FIGS. 1A and 1B.

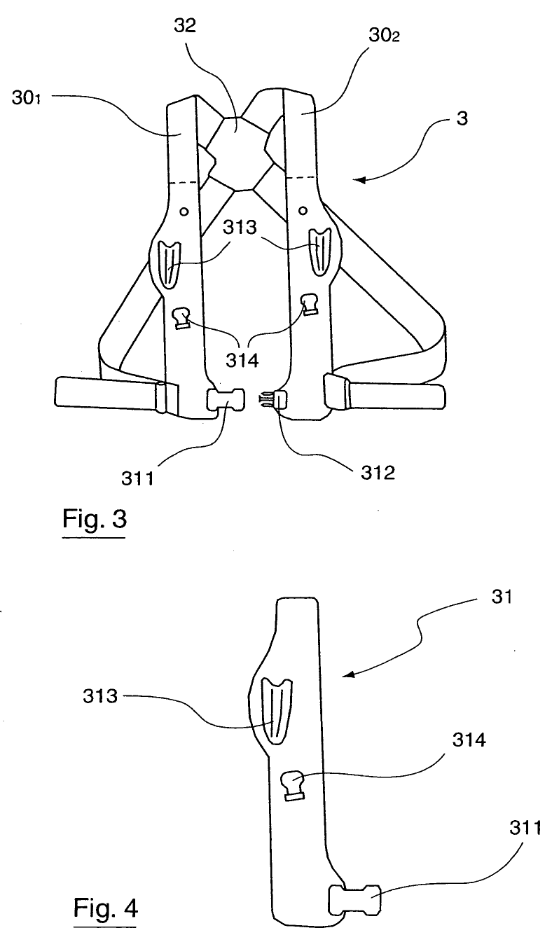

FIG. 3 shows a baby carrier harness which can hold the seat of FIGS. 1A and 1B.

FIG. 4 presents an example of a reinforcement of the harness of FIG. 3.

As already indicated, a baby carrier according to the invention comprises two elements, which can be separated: a harness and a seat (or carrying part).

In its general principle, a baby carrier according to the invention may be any of different types, especially that described in the patent published under the number FR-2 769 818 registered under the same name as this application. In other terms, the means of adjustment of the invention can be adapted to suit several types of baby carrier.

In particular, different types of harness may be used. According to the advantageous embodiment illustrated in FIG. 3, the harness 3 comprises two straps 30₁ and 30₂, which cross over on the wearer's back and which are held in this crossed position by means of a part 32 provided for this purpose. The front sections of these straps against which the seat rests each include a reinforcement as illustrated in FIG. 4.

This reinforcement provides the rigidity between the two attachment points it carries:
lower attachment elements 314 designed to co-operate with additional attachment means carried by the seat 1 (FIGS. 1A and 1B) on the inside leg.
upper attachment elements 313 attached to the top of the reinforcements 31, slightly offset, designed to co-operate with the additional attachment means carried by the lateral elements of the back of the seat.

Furthermore, according to one embodiment, it can run along the length of the strap to its lower end, bearing the attachment means 311, 312, and be equipped with attachment means 311, 312, permitting them to be fixed to one another. They may also be fixed to one another, more traditionally, by a belt attached to the straps.

According to the embodiment illustrated, the attachment elements are separate. According to another advantageous embodiment, they may be identical or similar, and in particular be of the same type as the elements 314.

Some parts of the harness may comprise classic adjustment means, to adapt the harness to the size and/or body shape of the wearer.

Such a harness allows the seat to be positioned on the front of the wearer, and the baby can be installed in the seat either facing towards or facing away from the wearer (the element designated by the “back” supports the baby's torso in this case).

According to the invention, the part of the seat 1 which forms the back has two portions 12 capable of being moved apart or towards one another, so that the width of the back can be adjusted. This operation is illustrated by FIGS. 1A and 1B, the width of the back being respectively reduced and increased.

As illustrated by these figures, means for moving the lateral elements 12₁, 12₂, apart or towards one another are formed by a cut out, marking a separation between the lateral elements 12 which run along the longitudinal axis of the back.

As shown by way of illustration, this cut out 14 runs down virtually along the entire length of the back.

According to this embodiment, the edges of the cut out 14 are joined by safety means, which ensure that the lateral elements cannot move beyond a pre-determined maximum distance separating them. These limiting means are formed by a strip of fabric 15, for example stitched next to the edges of the cut out.

The width of this strip of fabric can of course be varied. Apart from its function of limiting the distance separating the lateral elements, the strip of fabric also has a safety role in preventing the lateral elements from moving apart such that there is a space large enough to let a baby fall through.

This strip is preferably made from a perforated material, and for example 3D mesh, so as to allow air to circulate around the baby's back and consequently to limit the disadvantages linked in particular to sweating.

This strip of fabric 15 can of course be replaced by one or more riders, for example also made of fabric and possibly elastic, joining the two edges of the cut out.

In normal operation, this strip 15 does not play any role, the two edges are joined by the adjustment means presented below. When the opening of the cut out is reduced (FIG. 1A), it is folded over itself, for example to form a fan.

According to one essential aspect of the invention, the baby carrier comprises in fact means for adjusting the distance separating the lateral elements 12.

These adjustment means are formed according to the current embodiment by a cord 2 which passes through the entire length of the cut out 14, crossing over as shown in FIG. 2. The cord 2 passes through a number of guide elements 21 provided for this purpose on the edges of the said cut out 14.

In a similar way to a shoe or corset lace, it is therefore possible to pull the crossed laces to allow the edges of the cut out to move further apart, or on the contrary to pull the free ends of the cord to draw the edges of the cut out closer together.

The ends may be knotted together so as to maintain a given distance. A classic sliding clamping element 13 may also be envisaged.

It can be noted that the principle of the crossed cord is safe. Even if the ends of the cord are not attached or if they come loose accidentally, the cord will remain more or less in the same position, or will slide open slowly without sudden opening. As the ends of the cord have a stop element 16, the cord ensures that, in the same way as the strip of fabric 15, the distance between the edges of the cut out does not exceed a maximum distance.

Other embodiments of the adjustment means can of course be envisaged, in particular using additional attachment means such as for example self-adhesive strips or even press studs.

Furthermore, it is clear that variations of the invention may be envisaged. In particular, several cut outs may be provided (one on each shoulder for example) to permit different adjustments.

Advantageously, an adjustment is also provided at the baby's waist. In particular, this may be an adjustment of the depth of the seat the baby sits on, by changing the point of attachment or adjustment of the point of attachment 314 between the legs of the harness seat.

Thus, in FIGS. 1A and B, two buckles 18₁, 18₂, are provided (on each side) that can be attached selectively to the single attachment of the harness (FIG. 3).

The seat is therefore assembled to the harness by attaching the buckles 18₁, or 18₂, to the element 314, then the needles 19 to the upper attachment elements 313.

1. Baby carrier permitting a baby to be carried next to an adult, comprising a harness and a carrying part forming a seat for a baby, and comprising a part forming the back of the seat, wherein said part which forms the back of the seat has at least two portions that can be moved away from or closer to one another, so that the width of the said back part can be adjusted, the said portions being separated by a cut-out running along its longitudinal axis, on at least the majority of the length of the said part forming the back of the seat, at least one strip of fabric, made of a different material from that of the said back of the seat and which allows air to circulate, connecting the said portions, so as to permit ventilation and prevent the said cut out from moving beyond a maximum width.

2. Baby carrier of claim 1, and further comprising means of adjusting the opening of the said cut out.

3. Baby carrier of claim 2, wherein said means of adjustment comprise at least one cord running between the edges of the said cut out.

4. Baby carrier of claim 3, wherein said cord(s) pass through a number of guide elements provided for this purpose on the edges of the said cut out or close to it, forming a lacing system.

5. Baby carrier of claim 1, wherein the means of adjustment comprise means of attachment belonging to the following group:
self-adhesive strips;
press studs
zips
buttons.

6. Baby carrier of claim 1, and further comprising additional limiting means which prevent the distance between the said portions from exceeding a maximum distance.

7. Baby carrier of claim 6, wherein said limiting means comprise at least a cord running between the edges of the said cut out and whose ends are fixed.

8. Baby carrier of claim 1, wherein said strip(s) of fabric has/have 3D mesh.

9. Baby carrier of claim 1, and further comprising at least two strips of fabric running laterally.

10. Baby carrier of claim 1, wherein said strip(s) of fabric is/are made of an elastic fabric.

11. Baby carrier of claim 1, wherein said harness and the said carrying part can be separated.

12. Baby carrier of claim 1, wherein said harness has two straps, whose front sections, against which the seat rests, each include a reinforcement equipped with attachment means, allowing them to be attached to one another.

13. Baby carrier of claim 11, wherein the reinformcements carry attachment means, of the said carrying part.

14. Carrying part designed to equip a baby carrier according to claim 1.
